(19) United States
(12) Patent Application Publication
(10) Pub. No.: US 2010/0044926 A1
(43) Pub. Date: Feb. 25, 2010

(54) FABRICATING POLYMERIC NANOWIRES

(75) Inventor: Sunghoon Kwon, Seoul (KR)

Correspondence Address: KNOBBE MARTENS OLSON & BEAR LLP, 2040 MAIN STREET, FOURTEENTH FLOOR, IRVINE, CA, 92614, US

(73) Assignee: Seoul National University Research & Development Business Foundation (SNU R&DB FOUNDATION), Seoul (KR)

(21) Appl. No.: 12/198,028

(22) Filed: Aug. 25, 2008

(51) Int. Cl. B29C 35/08

(52) U.S. Cl. 264/496; 425/174.4

(57) ABSTRACT

Techniques for fabricating nanowires are disclosed.

### BACKGROUND

Recent development of semiconductor technology has reduced the size of electronic component devices, particularly the width of wires in the devices. As a result, the importance of nanowires for electrically connecting devices is ever-increasing. Nanowires have a wide range of applications depending on relevant substances. For example, nanowires have been used for devices for emitting/receiving light (optical usage). Furthermore, nanowires have been added to composite materials (mechanical usage). Although nanowires can be potentially used in many fields, typical nanowires are limited with regard to shape and size.

### SUMMARY

In one embodiment, a method for fabricating a nanowire comprises supplying resins to a fluidic channel having an array of a plurality of nanoscale holes on a surface, and forming nanowires by irradiating the resins by UV light through the nanoscale holes while the resins flow through the fluidic channel.

The Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

FIG. 1 is a schematic diagram illustrating an apparatus for fabricating a nanowire according to one illustrative embodiment.

FIG. 2 a schematic diagram illustrating a fluidic channel of a nanowire fabrication apparatus according to one illustrative embodiment.

FIG. 3 is a flow chart illustrating a method for fabricating a nanowire according to one illustrative embodiment.

FIG. 4 is a top view of a fluidic channel of a nanowire fabrication apparatus according to another illustrative embodiment.

FIG. 5 is a top view of a fluidic channel of a nanowire fabrication apparatus according to another illustrative embodiment.

FIG. 6 is a top view of a fluidic channel of a nanowire fabrication apparatus according to still another illustrative embodiment.

FIG. 7 is a top view of a fluidic channel of a nanowire fabrication apparatus according to still another illustrative embodiment.

### DETAILED DESCRIPTION

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented here. It will be readily understood that the components of the present disclosure, as generally described herein, and illustrated in the Figures, may be arranged, substituted, combined, and designed in a wide variety of different configurations, all of which are explicitly contemplated and make part of this disclosure.

In one embodiment, a method for fabricating a nanowire includes supplying resin to a fluidic channel having an array of a plurality of nanoscale holes on a surface, and forming nanowires by irradiating the resin with UV light transmitted through the nanoscale holes while the resin flows through the fluidic channel.

The array of the nanoscale holes may be oriented at an angle with regard to a flow direction of the resin. The resin may include photocurable resins. The method may further include varying respective widths of the nanoscale holes to form nanowires of different widths.

The method may further include varying the times or time intervals of the irradiation to form nanowires of different lengths. In addition, the resin may include a combination of different resins having different compositions where the different resins may be supplied to the fluidic channel from corresponding inlets. Further, each resin may include photocurable resins.

In another embodiment, a method for fabricating a nanowire comprises providing a fluidic channel having an array of nanoscale holes, flowing resin over the array, and irradiating a back side of the array by UV light to form nanowires as the resin passes over the nanoscale holes.

Further, by varying the duration of exposure to light, nanowires having different lengths may be fabricated. In addition, nanowires with different widths may be obtained by varying the sizes of corresponding holes.

In still another embodiment, an apparatus for fabricating a nanowire includes a fluid input control unit to receive resin, a channel unit positioned adjacent the fluid input control unit and provided with a plurality of fluidic channels, and an optical unit positioned adjacent the channel unit to supply light. Each fluidic channel may include an array of nanoscale holes in a channel surface. Resin provided to the fluid input control unit may flow on a first side of the array while a second side of the array may be irradiated by the optical unit.

The array of the nanoscale holes may be oriented at an angle with regard to a flow direction of resin in a channel. The channel unit may further include at least one inlet connected to each fluidic channel to separately supply resin to the fluidic channels. The channel unit may further include a plurality of inlets connected to each fluidic channel to supply resins having different compositions.

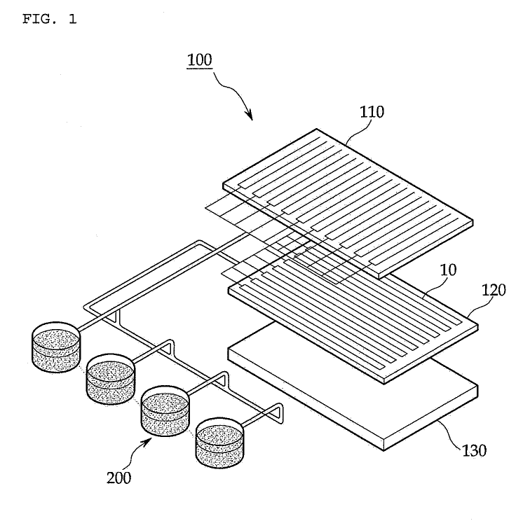

FIG. 1 is a schematic diagram illustrating an apparatus 100 for fabricating a nanowire according to one illustrative embodiment. Fabrication apparatus 100 includes a fluid input control unit 110 to receive a fluid, a channel unit 120 positioned adjacent the fluid input control unit 110 and provided with a plurality of fluidic channels 10, through which the fluid provided by the fluid input control unit 110 flows, and an optical unit 130 positioned adjacent the channel unit 120.

The fluid input control unit 110 may include a valve (not shown) to control fluid supplied to the control unit 110 from fluid supply units 200. The amount and velocity of fluid supplied to the fluid input control unit 110 may be controlled by adjusting the valve.

The channel unit 120 includes a plurality of fluidic channels 10, each of which may include at least one inlet (now shown) for receiving the fluid from the fluid input control unit 110.

The optical unit 130 may be an optical structure for supplying light, and may include, but is not limited to, a photonic crystal structure, a sensor, a source, and a waveguide.

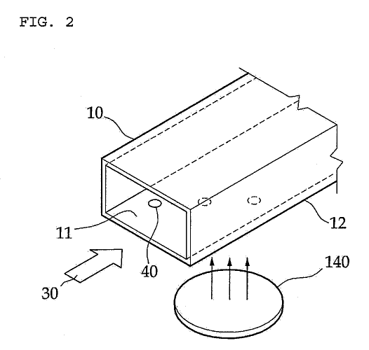

FIG. 2 is a schematic diagram illustrating a fluidic channel 10 according to one illustrative embodiment. Channel 10 includes a first side 11 having an array of nanoscale nanoholes 40 formed therein, and a second side 12, which may be irradiated by light provided by the optical unit 130. The number and structure of the nanoholes 40 may be varied depending on the structure and characteristics of the nanowire to be obtained, and are not limited to those shown in FIG. 2. Although the nanoholes 40 are shown in FIG. 2 to have a circular shape, any shape may be adopted.

The array of nanoholes 40 may be formed using various methods, which include, but are not limited to, electron beam lithography, two-photon lithography, and nanoimprinting. For example, an array of nanohole may be formed by depositing aluminum with a thickness of 90 nm on a wafer, defining a pattern of an array of nanoholes on a PMMA resist by electron beam lithography, and transferring the pattern to the aluminum layer by reactive ion etching. However, claimed subject matter is limited with regard to how nanoholes 40 are fabricated.

Light source 140 may be positioned adjacent to the fluidic channel 10 to emit light into the fluidic channel through the nanoholes 40. In response to the light, resin 30 flowing inside the fluidic channel 10 may be cured. Light source 140 may be, but is not limited to, a UV lamp. In addition, although the light source 140 is shown in FIG. 2 positioned below the fluidic channel 10, the light source 140 may have any shape or be arranged in any position that permits source 140 to provide light into the fluidic channel 10 through the nanoholes 40.

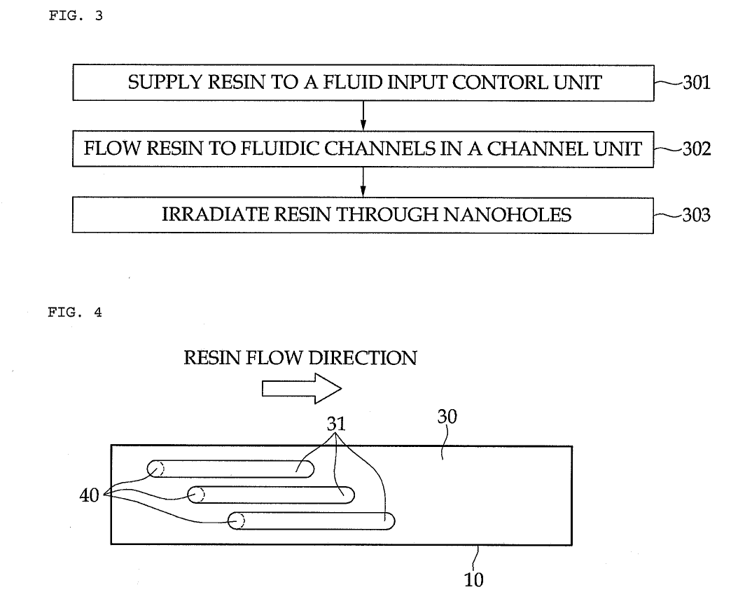

A method for fabricating a nanowire according to one illustrative embodiment will now be described with reference to FIGS. 1 through 3. FIG. 3 is a flow chart illustrating the method for fabricating a nanowire.

A resin 30 may be supplied from the fluid supply unit 200 to the fluid input control unit 110 as indicated by an arrow in FIG. 2 (301 in FIG. 3). Resin 30 includes a photocurable resin, i.e. a resin that can be cured in response to light emitted by source 140. When the light source 140 is a UV lamp, for example, the resin 30 may be photocurable epoxy acrylate. The resin 30 provided to the fluid input control unit 110 may flow to channels 10 in channel unit 120 (302 in FIG. 3). The amount or velocity of the resin 30 provided to the channel unit 120 may be regulated by adjusting the valve (not shown) included in the fluid input control unit 110.

Resin 30 supplied to the channel unit 120 may be in a liquid phase, and may flow through each fluidic channel 10. While resin 30 flows adjacent the first side 11 of a nanohole 40, light emitted by source 140 may irradiate the second side 12 of the nanohole 40 (303 in FIG. 3). In response to the light irradiated on the resin 30, the irradiated portion of the resin 30 may begin curing. Thus, as the liquid resin 30 flows past nanohole 40 in fluidic channel 10, the resin 30 may be cured by light from source 140 to form a nanowire. The length of a resulting cured nanowire product may depend on the irradiation time.

According to another embodiment, the nanoholes 40 may be arranged at an angle with regard to the direction of flow of the resin. FIG. 4 is a top view of a fluidic channel of a nanowire fabrication apparatus of another illustrative embodiment. Referring to FIG. 4, the nanoholes 40 are arrayed at an angle with regard to the direction of flow of the resin (depicted by the arrow in FIG. 4). Upon irradiation of side 12 of the fluidic channel 10 having nanoholes 40, the resin 30 may be cured, and nanowires 31 thus formed as shown in FIG. 4.

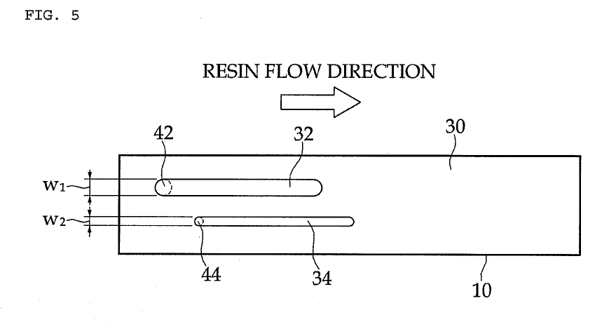

According to another embodiment, the nanowire fabrication apparatus may employ nanoholes having different widths. FIG. 5 is a top view of a fluidic channel 10 of a nanowire fabrication apparatus according to another illustrative embodiment. Channel 10 includes a first nanohole 42 having a width W₁ larger than a width W₂ of a second nanohole 44. As a result, a nanowire 32 formed on the nanohole 42 has a width larger than that of a nanowire 34 formed on the nanohole 44. In FIG. 5, the arrow indicates the flow direction of the resin 30.

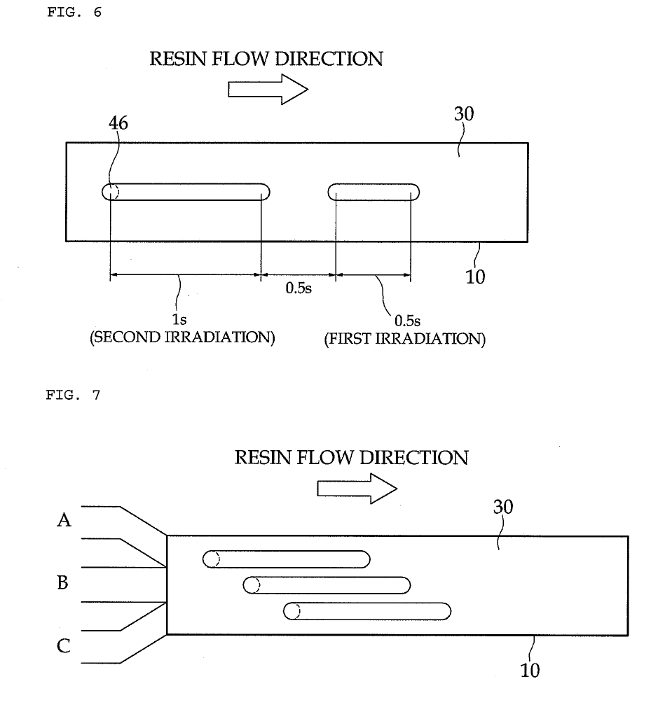

FIG. 6 is a top view of a fluidic channel 10 of a nanowire fabrication apparatus according to still another illustrative embodiment. Although only one nanohole 46 is illustrated in FIG. 6 for brevity, the present disclosure is not limited to this illustration or to any specific number of nanoholes. FIG. 6 illustrates the result of employing different irradiation intervals. In this particular example, the resin 30 has been irradiated with light through nanohole 46 for a first irradiation interval of about 0.5 second. After an interval of about 0.5 second without irradiation, the resin 30 has been irradiated through the same nanohole for a second irradiation interval of about 1 second. In this example, if the resin 30 flows at a velocity of about 100 nm/s, the first irradiation interval creates a nanowire having a length of about 50 nm, and the second irradiation interval creates a nanowire having a length of about 100 nm. Thus, by controlling the time duration and interval of irradiation, nanowires of different lengths can be obtained at different intervals. In FIG. 6, the arrow indicates the flow direction of the resin 30.

FIG. 7 is a top view of a fluidic channel 10 of a nanowire fabrication apparatus according to another illustrative embodiment. In this embodiment, the channel unit 120 (FIG. 1) includes a plurality of inlets A, B and C for supplying resins to each fluidic channel 10. Although FIG. 7 shows three inlets connected to the fluidic channel 10, claimed subject matter is not limited to specific numbers of inlets. Resin 30 may be supplied to the fluidic channel 10 from inlets A, B, and C. The arrow indicates the flow direction of the resin 30 inside the fluidic channel 10. The inlets A, B and C may each supply resin of the same composition, or some or all of the inlets may supply resin having different compositions. A plurality of sub-channels (not shown) may be arranged inside the fluidic channel 10 so that resin supplied by the respective inlets does not mix with each other inside the fluidic channel. Alternatively, resin supplied by the respective inlets may undergo laminar flow so that they do not mix with each other inside the fluidic channel 10.

Nanowire fabricated in accordance with claimed subject matter may be used in applications such as solar cells, textiles, and bio sensors, to name only a few. For example, a solar cell may be manufactured in the form of a plastic cover or paint using the nanowire. Further, in another example, the nanowire may be used for manufacturing a textile. Furthermore, the nanowire may be used for the nano-bio sensor. The preceding examples represent only a few of the many possible applications and the application of the nanowire according to the present disclosure is not limited thereto.

From the foregoing, it will be appreciated that various embodiments of the present disclosure have been described herein for purposes of illustration, and that various modifications may be made without departing from the scope and spirit of the present disclosure. Accordingly, the various embodiments disclosed herein are not intended to be limiting, with the true scope and spirit being indicated by the following claims.

1. A method for fabricating a nanowire, comprising:
supplying resin to a fluidic channel having an array of nano scale holes in a surface of the fluidic channel; and
forming nanowires by irradiating the resin through the nanoscale holes while flowing the resin through the fluidic channel.

2. The method of claim 1, wherein the array of the nanoscale holes are disposed at a an angle with regard to a flow direction of the resin.

3. The method of claim 1, wherein the resin comprises photocurable resin.

4. The method of claim 1, wherein the nanoscale holes have different widths.

5. The method of claim 1, further comprising irradiating the resin over different time intervals.

6. The method of claim 1, wherein the resin comprises a mixture of resins.

7. The method of claim 6, wherein supplying resin further comprises supplying each resin of the mixture of resins from a corresponding inlet connected to the fluidic channel.

8. The method of claim 6, wherein each resin of the mixture of resins comprises a photocurable resin.

9. The method of claim 1, wherein irradiating the resin comprises irradiating the resin with UV light.

10. A method for fabricating a nanowire, comprising:
preparing a fluidic channel having a plurality of nanoscale holes;
flowing resin adjacent to the nanoscale holes; and
irradiating the resin through the nanoscale holes to form nanowires.

11. The method of claim 10, wherein irradiating the resin comprises irradiating the resin over different time intervals.

12. The method of claim 10, wherein the nanoscale holes have different widths.

13. The method of claim 10, wherein the resin comprises photocurable resin.

14. The method of claim 10, wherein irradiating the resin comprises irradiating the resin with UV light.

15. An apparatus for fabricating a nanowire, comprising:
a fluid input control unit to receive resin;
a channel unit disposed adjacent the fluid input control unit and provided with a plurality of fluidic channels; and
an optical unit disposed adjacent the channel unit,
wherein each fluidic channel comprises a plurality of nanoscale holes in a surface of the fluidic channel, and
wherein the optical unit is configured to irradiate the resin through the plurality of nanoscale holes.

16. The apparatus of claim 15, wherein the plurality of nanoscale holes are disposed at an angle with regard to a flow direction of the resin.

17. The apparatus of claim 15, wherein the channel unit further comprises at least one inlet connected to at least one fluidic channel to supply resin to the fluidic channel.

18. The apparatus of claim 15, wherein the resin comprises a mixture of resins.

19. The apparatus of claim 15, wherein the optical unit comprises a UV light source.
